(19) United States
(12) Patent Application Publication
(10) Pub. No.: US 2007/0138906 A1
(43) Pub. Date: Jun. 21, 2007

(54) Methods of manufacturing piezoelectric actuator and liquid ejection head, piezoelectric actuator, liquid ejection head, and image forming apparatus

(75) Inventor: Ryuji Tsukamoto, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/640,959

(22) Filed: Dec. 19, 2006

(30) Foreign Application Priority Data
Dec. 20, 2005 (JP) 2005-366941

(51) Int. Cl. H02N 2/00

(52) U.S. Cl. 310/311

(57) ABSTRACT

The method of manufacturing a piezoelectric actuator includes the steps of: forming a first metal oxide film which contains at least one element of aluminum, zirconium and silicon and has a film thickness of not less than 0.1 μm and not greater than 3.5 μm, on a first surface of a main substrate containing iron; forming a piezoelectric element including a piezoelectric body formed by a thin film formation method, on the first metal oxide film formed on the first surface of the main substrate; and calcining the piezoelectric body by carrying out heat treatment at a temperature of not less than 400° C., in a state where the piezoelectric element has been formed on the first metal oxide film formed on the first surface of the main substrate.

### BACKGROUND OF THE INVENTION

1. Field of the Invention

The present invention relates to a method of manufacturing a piezoelectric actuator, a method of manufacturing a liquid ejection head, a piezoelectric actuator, a liquid ejection head and an image forming apparatus, and more particularly, to technology for manufacturing a liquid ejection head which ejects liquid from a nozzle and a structure for such a liquid ejection head.

2. Description of the Related Art

An inkjet recording apparatus is known which includes a recording head (liquid ejection head) in which the wall surface of a pressure chamber is deformed through the displacement of a piezoelectric element, and ink inside the pressure chamber is pressurized, thereby causing an ink droplet to be ejected from a nozzle connected to the pressure chamber.

In recent years, since higher levels of integration have been sought for recording heads (which is, hereinafter, simply referred to as “head”) used in inkjet recording apparatuses, then, in order to achieve high integration of the head and ensure high reliability and high performance, various modifications have been contrived in respect of the structure and manufacture. For example, in a case where a thin film of a piezoelectric element (piezoelectric actuator) is used as an ejection force generating element, it is possible to form a piezoelectric body layer and electrodes (in the shape of a thin film) onto a substrate (diaphragm) by means of thin film formation technology, such as an aerosol deposition method, a sol gel technique, a screen printing method, a sputtering method, and CVD, and the like.

Japanese Patent Application Publication No. 2005-35013 discloses a method of manufacturing a liquid transfer device in which a piezoelectric film is formed onto a diaphragm arranged on an ink storage chamber and annealed, thereby obtaining a piezoelectric body having a thin film thickness. Even if the piezoelectric body thus obtained is driven at a low drive voltage, the piezoelectric body can apply sufficient pressure to the liquid inside the liquid chamber and consequently the liquid can be moved to the exterior from the liquid chamber. Specifically, Japanese Patent Application Publication No. 2005-35013 discloses technology in which, by providing the diaphragm with the ink storage chamber so that the structure has a high rigidity, even a thin diaphragm having a thickness of 10 μm to 50 μm can sufficiently withstand an impact force during the piezoelectric film formation.

Japanese Patent Application Publication No. 11-204849 discloses technology for obtaining an actuator having high mechanical strength and reliability provided with an intermediate layer which is formed between a silicon substrate and a lead-based piezoceramic substrate, which prevents diffusion of the lead into the substrate when the piezoceramic substrate is calcined on the silicon substrate.

Japanese Patent Application Publication No. 2001-152361 discloses the structure of a piezoceramic pressure film formed by a gas deposition method. In this structure, the film formation by gas deposition is carried out after forming an intermediate film on a substrate, and accordingly the damage of the substrate is reduced and reduction of the mechanical strength of the laminated structural body constituted by the thick piezoelectric ceramic film and the substrate is prevented.

However, if a piezoelectric body composed of PZT (Pb(Zr—Ti)O₃: lead zirconate titanate), or the like, is formed onto a diaphragm (substrate) of a metal containing iron such as stainless steel (SUS), and a heat treatment is then carried out at a high temperature of 400° C. or above, then there is a possibility that the iron contained in the diaphragm diffuses into the piezoelectric body and hence the performance of the piezoelectric body may decline. If the iron diffuses into the piezoelectric body, the performance decline, such as reduction of the piezoelectric d constant and the decline of the insulating properties of the piezoelectric element, may arise.

In the invention disclosed in Japanese Patent Application Publication No. 2005-35013, an annealing process is carried out for several hours in a high-temperature atmosphere of 600° C. to 750° C. (aerosol deposition method) or 600° C. to 1200° C. (sol gel method), and therefore, in a case of a stainless steel substrate used for the diaphragm, the iron contained in the diaphragm diffuses into a piezoelectric element and degrades the performance of the piezoelectric element. Furthermore, it is required for the annealing process for piezoelectric elements deposited by AD (aerosol deposition) to be carried out in a normal air atmosphere, and hence there are possibilities that the surface of the diaphragm to be annealed simultaneously with the annealing of the piezoelectric elements is oxidized, thus leading to a decline in the durability of the diaphragm and deterioration of its bonding characteristics with respect to other members.

Japanese Patent Application Publications No. 11-204849 and No. 2001-152361 disclose technology for preventing diffusion of the lead component contained in piezoceramic elements into the substrate (base substrate) by providing an intermediate layer between the substrate and each piezoceramic element, and technology for reducing damage to the substrate (base substrate) during deposition of the piezoceramic material. As in the case of Japanese Patent Application Publication No. 2005-35013, although there is a possibility that metal elements, such as iron, contained in the substrate diffuse into the piezoceramic elements, there is no disclosure regarding the decline in the performance of the piezoceramic elements as a result of diffusion of the metal elements such as iron.

### SUMMARY OF THE INVENTION

The present invention has been contrived in view of the foregoing circumstances, an object thereof being to provide a method of manufacturing a piezoelectric actuator, a method of manufacturing a liquid ejection head, a piezoelectric actuator, a liquid ejection head and an image forming apparatus, whereby a metal element contained in a substrate is prevented from diffusing into a piezoelectric element so that degradation of the performance of the piezoelectric element can be avoided and the reliability of the piezoelectric element can be ensured.

In order to attain the aforementioned object, the present invention is directed to a method of manufacturing a piezoelectric actuator comprising the steps of: forming a first metal oxide film which contains at least one element of aluminum, zirconium and silicon and has a film thickness of not less than 0.1 μm and not greater than 3.5 μm, on a first surface of a main substrate containing iron; forming a piezoelectric element including a piezoelectric body formed by a thin film formation method, on the first metal oxide film formed on the first surface of the main substrate; and calcining the piezoelectric body by carrying out heat treatment at a temperature of not less than 400° C., in a state where the piezoelectric element has been formed on the first metal oxide film formed on the first surface of the main substrate.

According to this aspect of the present invention, even if the piezoelectric body is formed on the main substrate containing iron by means of a thin film formation method (for example, aerosol deposition) and the piezoelectric body is then calcined by performing heat treatment at a temperature of 400° C. or above, the iron contained in the main substrate is prevented from diffusing into the piezoelectric body by setting the thickness of the metal oxide film to not less than 0.1 μm, thereby avoiding deterioration in the performance of the piezoelectric body and decline in the reliability of the piezoelectric body. Moreover, by setting the thickness of the metal oxide film to not greater than 3.5 μm, the function of the diaphragm (prescribed amount of displacement) is ensured.

The main substrate containing iron may be a metal substrate made of stainless steel, or the like. There is a mode in which this substrate functions as a diaphragm which deforms in accordance with the bending deformation of the piezoelectric element.

There is a mode in which the step of the piezoelectric body formation includes the step of forming a lower electrode onto the metal oxide film and the step of forming piezoelectric body onto the lower electrode. Furthermore, there is also a mode in which the step of the piezoelectric body formation includes the step of forming an upper electrode on top of the piezoelectric body (i.e., on the other surface of the piezoelectric body on which the lower electrode is arranged) after the calcination of the piezoelectric body.

Preferably, the method of manufacturing a piezoelectric actuator further comprises the step of forming a second metal oxide film which contains at least one element of aluminum, zirconium and silicon, on a second surface of the main substrate reverse to the first surface.

According to this aspect of the invention, by also providing the metal oxide film on the surface of the diaphragm where the piezoelectric element is not formed, degradation (oxidation) of the surface of the diaphragm where the piezoelectric element is not formed is prevented, and deterioration of bonding characteristics can also be prevented.

In cases where the metal oxide film is formed on both of the first surface and the second surface of the diaphragm, preferably, the thickness of the (first) metal oxide film arranged on the first surface is not greater than 0.5 μm. Furthermore, preferably, the combined thickness of the (first) metal oxide film formed on the first surface and the (second) metal oxide film formed on the second surface is not greater than 3.5 μm.

In order to attain the aforementioned object, the present invention is also directed to a method of manufacturing a liquid ejection head which ejects liquid onto a recording medium, comprising the steps of: forming a first metal oxide film which contains at least one element of aluminum, zirconium and silicon and has a film thickness of not less than 0.1 μm and not greater than 3.5 μm, on a first surface of a main substrate containing iron; forming a piezoelectric element including a piezoelectric body formed by a thin film formation method, on the first metal oxide film formed on the first surface of the main substrate; calcining the piezoelectric body by carrying out heat treatment at a temperature of not less than 400° C., in a state where the piezoelectric element has been formed on the first metal oxide film formed on the first surface of the main substrate; and bonding a liquid chamber substrate including a liquid chamber for accommodating the liquid, to a second surface of the main substrate reverse to the first surface, after calcining the piezoelectric body.

According to this aspect of the present invention, since diffusion of the iron contained in the main substrate into the piezoelectric element is prevented, then it is possible to prevent deterioration of the performance of the piezoelectric element and to obtain a liquid ejection head which achieves desirable liquid ejection.

In addition to the liquid chamber accommodating liquid, a flow channel which connects with the liquid chamber, and the like may also be formed in the liquid chamber substrate. There is a mode in which the liquid chamber substrate is constituted by stacking a plurality of substrates. For example, there is a mode in which a plurality of substrates which have an opening, a hole, and a groove that are to form the liquid chamber, the flow channel, and the like, in the liquid chamber substrate, are prepared, and the substrates are stacked and bonded together while being registered in position.

Preferably, the method of manufacturing a liquid ejection head further comprises the step of forming a second metal oxide film which contains at least one element of aluminum, zirconium and silicon, on the second surface of the main substrate.

Since the metal oxide films are respectively formed onto both of the first surface on which the piezoelectric element is arranged and the second surface to which the liquid chamber substrate is bonded, then diffusion of the iron contained in the main substrate into the piezoelectric element is prevented by the (first) metal oxide film formed on the first surface, and deterioration of the second surface is prevented by the (second) metal oxide film formed on the second surface. Hence, the bonding characteristics between the main substrate and the liquid chamber substrate are ensured. Furthermore, the metal oxide film on a portion of the second surface of the main substrate which forms an inner surface (e.g., a ceiling) of the pressure chamber functions as a protective film which protects the main substrate from the liquid accommodated in the liquid chamber.

In order to attain the aforementioned object, the present invention is also directed to a method of manufacturing a liquid ejection head which ejects liquid onto a recording medium, comprising the steps of: forming a first metal oxide film which contains at least one element of aluminum, zirconium and silicon and has a thickness of not less than 0.1 μm and not greater than 3.5 μm, on a first surface of a main substrate containing iron; bonding a liquid chamber substrate including a liquid chamber for accommodating the liquid, to a second surface of the main substrate reverse to the first surface; forming a piezoelectric element including a piezoelectric body formed by a thin film formation method, on the first metal oxide film formed on the first surface of the main substrate, at a position corresponding to the liquid chamber of a laminated body in which the main substrate and the liquid chamber substrate are bonded together; and calcining the piezoelectric body by carrying out heat treatment at a temperature of not less than 400° C., in a state where the piezoelectric element has been formed on the first metal oxide film formed on the first surface of the main substrate.

In a mode where the same material is used for the main substrate and the liquid chamber substrate, then the main substrate and the liquid chamber substrate can be bonded together by diffusion bonding. Furthermore, warping of the main substrate and a flow channel substrate after heat treatment is reduced, and the reliability of the bond is hence improved.

Preferably, the method of manufacturing a liquid ejection head further comprises the step of forming second metal oxide films which contain at least one element of aluminum, zirconium and silicon, on a portion of the second surface that corresponds to the liquid chamber in the liquid chamber substrate and on an inner wall surface of the liquid chamber in the liquid chamber substrate.

According to this aspect of the present invention, it is possible to prevent degradation of the liquid chamber and to improve resistance to liquid of the interior of the liquid chamber, by means of the (second) metal oxide film formed onto an inner wall surface (interior) of the liquid chamber. In other words, the (second) metal oxide film formed onto the interior of the liquid chamber functions as a protective film for the interior of the liquid chamber.

Preferably, the method of manufacturing a liquid ejection head further comprises the step of forming a second metal oxide film which contains at least one element of aluminum, zirconium and silicon, on a first surface of the liquid chamber substrate reverse to a second surface of the liquid chamber substrate to which the main substrate is bonded.

According to this aspect of the present invention, it is possible to prevent deterioration of the liquid chamber substrate due to oxidation. In a mode where another substrate, or the like, is bonded onto the surface of the liquid chamber substrate reverse to the surface on which the main substrate is arranged, deterioration in the bonding characteristics due to degradation of this bonding surface is prevented.

Preferably, the method of manufacturing a liquid ejection head further comprises the step of bonding a nozzle substrate including a nozzle for ejecting the liquid accommodated in the liquid chamber, to a first surface of the liquid chamber substrate reverse to a second surface of the liquid chamber substrate to which the main substrate is bonded.

The term “nozzle” here may also include an opening section from which liquid is ejected and a flow channel which connects to this opening section. This flow channel may be constituted by a plurality of flow paths having different diameters, and it may have a tapered shape.

In order to attain the aforementioned object, the present invention is directed to a piezoelectric actuator comprising: a main substrate which contains iron; a first metal oxide film which is formed on a first surface of the main substrate, contains at least one element of aluminum, zirconium and silicon, and has a film thickness of not less than 0.1 μm and not greater than 3.5 μm; and a piezoelectric element including a piezoelectric body formed on the first metal oxide film on the first surface of the main substrate.

There is a mode in which the piezoelectric element comprises: an upper electrode (individual electrode); a lower electrode (common electrode); and a piezoelectric film (layer), such as PZT (lead zirconate titanate), formed between the upper electrode and the lower electrode. If a prescribed drive signal (drive voltage) is applied between the upper electrode and the lower electrode, a deflection deformation occurs in the piezoelectric element. Piezoelectric elements to which the present invention can be applied include a d₃₁ mode piezoelectric element which generates a bending deformation in a direction substantially perpendicular to the direction (the direction of the electric field inside the piezoelectric body) of application of a voltage.

There is a mode of the piezoelectric actuator in which a substrate (diaphragm) to which the piezoelectric element is bonded is deformed in accordance with the bending deformation of the piezoelectric element.

Preferably, the piezoelectric actuator further comprises a second metal oxide film which is formed on a second surface of the main substrate reverse to the first surface and contains at least one element of aluminum, zirconium and silicon.

This aspect of the present invention is preferable from the viewpoint of reducing warping of the main substrate due to the heat treatment for calcining the piezoelectric element, and the like.

Preferably, each of the main substrate and the piezoelectric body has a thickness of not less than 1 μm and not greater than 40 μm.

The main substrate and the piezoelectric body may have substantially the same thickness, or they may have different thicknesses.

In order to attain the aforementioned object, the present invention is also directed to a liquid ejection head which ejects liquid toward a recording medium, comprising: a main substrate which contains iron; a metal oxide film which is formed on a first surface of the main substrate, contains at least one element of aluminum, zirconium and silicon, and has a film thickness of not less than 0.1 μm and not greater than 3.5 μm; a piezoelectric element including a piezoelectric body formed on the metal oxide film on the first surface of the main substrate; and a liquid chamber substrate which includes a liquid chamber for accommodating the liquid, and is bonded to a second surface of the main substrate reverse to the first surface.

The liquid ejection head may be a line type head having a row of nozzles of a length corresponding to the full width of a recording medium (the width of the possible image formation region of a recording medium), or a serial head which uses a short head having a row of nozzles of a length that does not reach the full width of the recording medium, and in which this head is moved in the breadthways direction of the recording medium.

A line type of liquid ejection head may be formed to a length corresponding to the full width of the recording medium by combining short heads each having a row of nozzles which does not reach a length corresponding to the full width of the recording medium, in such a manner that these short heads are joined together in a staggered matrix fashion.

The liquid may be ink used in an inkjet recording apparatus, a chemical solution such as resist, or a treatment liquid. The liquid has properties (e.g., viscosity, etc.) which allow it to be ejected from a nozzle provided in the liquid ejection head.

Moreover, the term “recording medium” is a medium on which liquid ejected from an ejection hole is deposited, and this term includes various types of media, irrespective of material and size, such as continuous paper, cut paper, sealed paper, resin sheets including OHP sheets, film, cloth, and other materials.

In order to attain the aforementioned object, the present invention is also directed to an image forming apparatus comprising a liquid ejection head including: a main substrate which contains iron; a metal oxide film which is formed on a first surface of the main substrate, contains at least one element of aluminum, zirconium and silicon, and has a film thickness of not less than 0.1 μm and not greater than 3.5 μm; a piezoelectric element including a piezoelectric body formed on the metal oxide film on the first surface of the main substrate; and a liquid chamber substrate which includes a liquid chamber for accommodating the liquid, and is bonded to a second surface of the main substrate reverse to the first surface.

The image forming apparatus includes an inkjet recording apparatus which forms a desired image by ejecting ink from a nozzle onto a recording medium. Here, the term “image” does not only mean images such as photographs and pictures, but also means text in the form of characters and symbols, and shapes such as a wiring pattern formed on a wiring substrate, and the like.

According to the present invention, even if a piezoelectric body which is formed on a main substrate containing iron by means of a thin film formation method (for example, aerosol deposition) is calcined by performing heat treatment at a temperature of 400° C. or above, the iron contained in the main substrate is prevented from diffusing into the piezoelectric body by setting the thickness of the first metal oxide film to 0.1 μm or more, thus avoiding deterioration in the performance of the piezoelectric body and decline in the reliability of the piezoelectric body. Furthermore, by setting the thickness of the first metal oxide film to 3.5 μm or less, the function of the diaphragm (prescribed amount of displacement) can be ensured.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1 is a general schematic drawing of an inkjet recording apparatus comprising a head according to an embodiment of the present invention;

FIG. 2 is a principal plan diagram of the peripheral area of a print unit in the inkjet recording apparatus shown in FIG. 1;

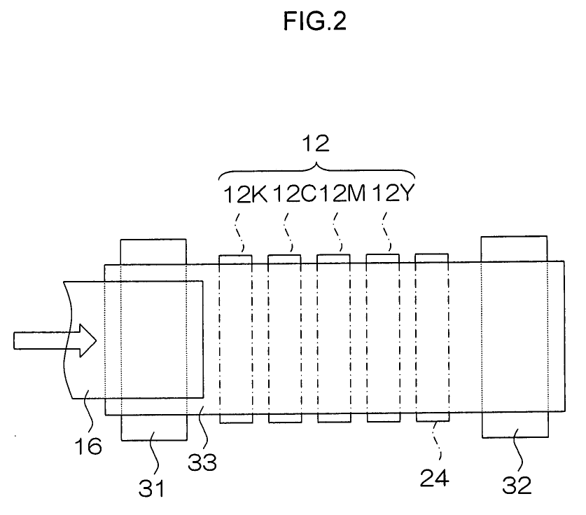

FIGS. 3A to 3C are plan view perspective diagrams showing embodiments of the composition of a print head;

FIGS. 4A and 4B are cross-sectional diagrams along line 4-4 in FIGS. 3A and 3B;

FIG. 5 is a principal block diagram showing a system configuration of the inkjet recording apparatus shown in FIG. 1;

FIG. 6 is a table showing the range of thickness of a metal oxide film;

FIG. 7 is a diagram showing steps for manufacturing a head according to an embodiment of the present invention;

FIG. 8 is a diagram showing a further mode of the head shown in FIGS. 4A and 4B; and

FIG. 9 is a diagram showing steps for manufacturing the head shown in FIG. 8.

### DESCRIPTION OF THE PREFERRED EMBODIMENTS

General Composition of Inkjet Recording Apparatus

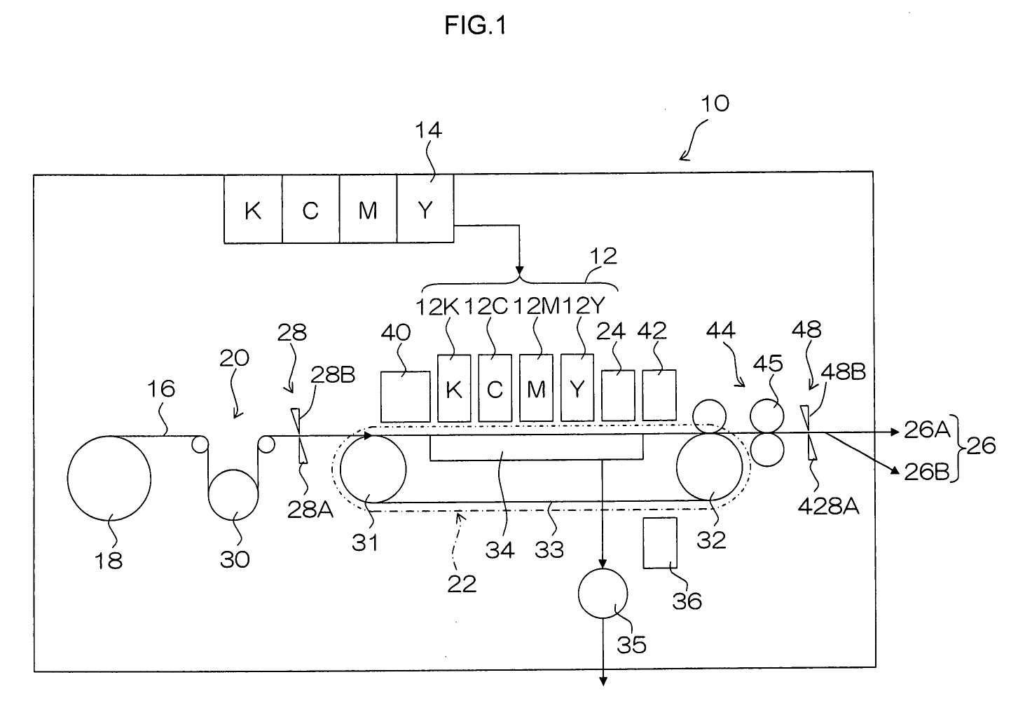

FIG. 1 is a general schematic drawing showing an embodiment of an inkjet recording apparatus according to the present invention. As shown in FIG. 1, the inkjet recording apparatus 10 comprises: a printing unit 12 having a plurality of heads 12K, 12C, 12M, and 12Y for ink colors of black (K), cyan (C), magenta (M), and yellow (Y), respectively; an ink storing and loading unit 14 for storing inks of K, C, M and Y to be supplied to the print heads 12K, 12C, 12M, and 12Y; a paper supply unit 18 for supplying recording paper 16; a decurling unit 20 for removing curl in the recording paper 16 supplied from the paper supply unit 18; a suction belt conveyance unit 22 disposed facing the nozzle faces (ink-droplet ejection faces) of the heads 12K, 12C, 12M, and 12Y, for conveying the recording paper 16 (recording medium) while keeping the recording paper 16 flat; a print determination unit 24 for reading the printed result produced by the printing unit 12; and a paper output unit 26 for outputting image-printed recording paper (printed matter) to the exterior.

In FIG. 1, a magazine for rolled paper (continuous paper) is shown as an embodiment of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which roll paper is used, a cutter 28 is provided as shown in FIG. 1, and the roll paper is cut into a desired size by the cutter 28. The cutter 28 has a stationary blade 28A whose length is not less than the width of the conveyor pathway of the recording paper 16, and a round blade 28B which moves along the stationary blade 28A. The stationary blade 28A is disposed on the reverse side of the printed surface of the recording paper 16, and the round blade 28B is disposed on the printed surface side across the conveyance path from the stationary blade 28A. When cut paper is used, the cutter 28 is not required.

In the case of a configuration in which a plurality of types of recording paper can be used, it is preferable that an information recording medium such as a bar code and a wireless tag containing information about the type of paper is attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the heads 12K, 12C, 12M, and 12Y and the sensor face of the print determination unit 24 forms a plane.

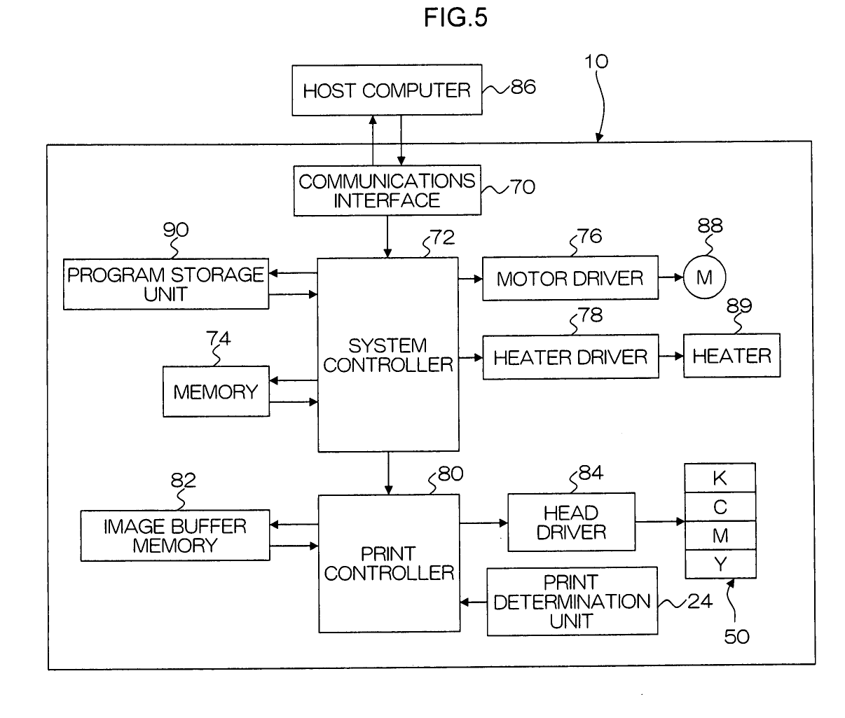

The belt 33 has a width that is greater than the width of the recording paper 16, and a plurality of suction apertures (not shown) are formed on the belt surface. A suction chamber 34 is disposed in a position facing the sensor surface of the print determination unit 24 and the nozzle surface of the printing unit 12 on the interior side of the belt 33, which is set around the rollers 31 and 32, as shown in FIG. 1. The suction chamber 34 provides suction with a fan 35 to generate a negative pressure, and the recording paper 16 on the belt 33 is held by suction. The belt 33 is driven in the clockwise direction in FIG. 1 by the motive force of a motor 88 shown in FIG. 5 (not shown in FIG. 1) being transmitted to at least one of the rollers 31 and 32, which the belt 33 is set around, and the recording paper 16 held on the belt 33 is conveyed from left to right in FIG. 1.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, embodiments thereof include a configuration in which the belt 33 is nipped with cleaning rollers such as a brush roller and a water absorbent roller, an air blow configuration in which clean air is blown onto the belt 33, or a combination of these. In the case of the configuration in which the belt 33 is nipped with the cleaning rollers, it is preferable to make the line velocity of the cleaning rollers different than that of the belt 33 to improve the cleaning effect.

The inkjet recording apparatus 10 can comprise a roller nip conveyance mechanism, instead of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the printing unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

The print unit 12 has so-called “full line heads” in which a line head having a length corresponding to the maximum paper width is arranged in a direction (main scanning direction) that is perpendicular to the paper feed direction (sub-scanning direction). The heads 12K, 12C, 12M, and 12Y forming the print unit 12 are constituted by line heads in which a plurality of ink ejection ports (nozzles) are arranged through a length exceeding at least one edge of the maximum size recording paper 16 intended for use with the inkjet recording apparatus 10.

The heads 12K, 12C, 12M, and 12Y corresponding to respective ink colors are disposed in the order, black (K), cyan (C), magenta (M) and yellow (Y), from the upstream side (left-hand side in FIG. 1), following the direction of conveyance of the recording paper 16. A color print can be formed on the recording paper 16 by ejecting the inks from the heads 12K, 12C, 12M, and 12Y, respectively, onto the recording paper 16 while conveying the recording paper 16.

The print unit 12, in which the full-line heads covering the entire width of the paper are thus provided for the respective ink colors, can record an image over the entire surface of the recording paper 16 by performing the action of moving the recording paper 16 and the print unit 12 relatively to each other in the paper conveyance direction just once (in other words, by means of a single sub-scan). Higher-speed printing is thereby made possible and productivity can be improved in comparison with a shuttle type head configuration in which a recording head moves back and forth reciprocally in the main scanning direction, which is perpendicular to the paper conveyance direction.

Although a configuration with four standard colors, K M C and Y, is described in the present embodiment, the combinations of the ink colors and the number of colors are not limited to these, and light and/or dark inks can be added as required. For example, a configuration is possible in which heads for ejecting light-colored inks, such as light cyan and light magenta, are added.

As shown in FIG. 1, the ink storing and loading unit 14 has ink tanks for storing the inks of the colors corresponding to the respective heads 12K, 12C, 12M, and 12Y, and the respective tanks are connected to the heads 12K, 12C, 12M, and 12Y by means of channels (not shown). The ink storing and loading unit 14 has a warning device (for example, a display device, an alarm sound generator, or the like) for warning when the remaining amount of any ink is low, and has a mechanism for preventing loading errors among the colors.

The print determination unit 24 has an image sensor (line sensor) for capturing an image of the ink-droplet deposition result of the printing unit 12, and functions as a device to check for ejection defects, such as clogs of the nozzles, from the ink-droplet deposition results evaluated by the image sensor.

The print determination unit 24 of the present embodiment is configured with at least a line sensor having rows of photoelectric transducing elements with a width that is greater than the ink-droplet ejection width (image recording width) of the heads 12K, 12C, 12M, and 12Y. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

The print determination unit 24 reads a test pattern image printed by the heads 12K, 12C, 12M, and 12Y for the respective colors, and the ejection of each head is determined. The ejection determination includes the presence of the ejection, measurement of the dot size, and measurement of the dot deposition position.

A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not shown in drawings, the paper output unit 26A for the target prints is provided with a sorter for collecting prints according to print orders.

Structure of a Head

Next, the structure of a head is described below. The heads 12K, 12C, 12M, and 12Y of the respective ink colors have the same structure, and a reference numeral 50 is hereinafter designated to any of the heads.

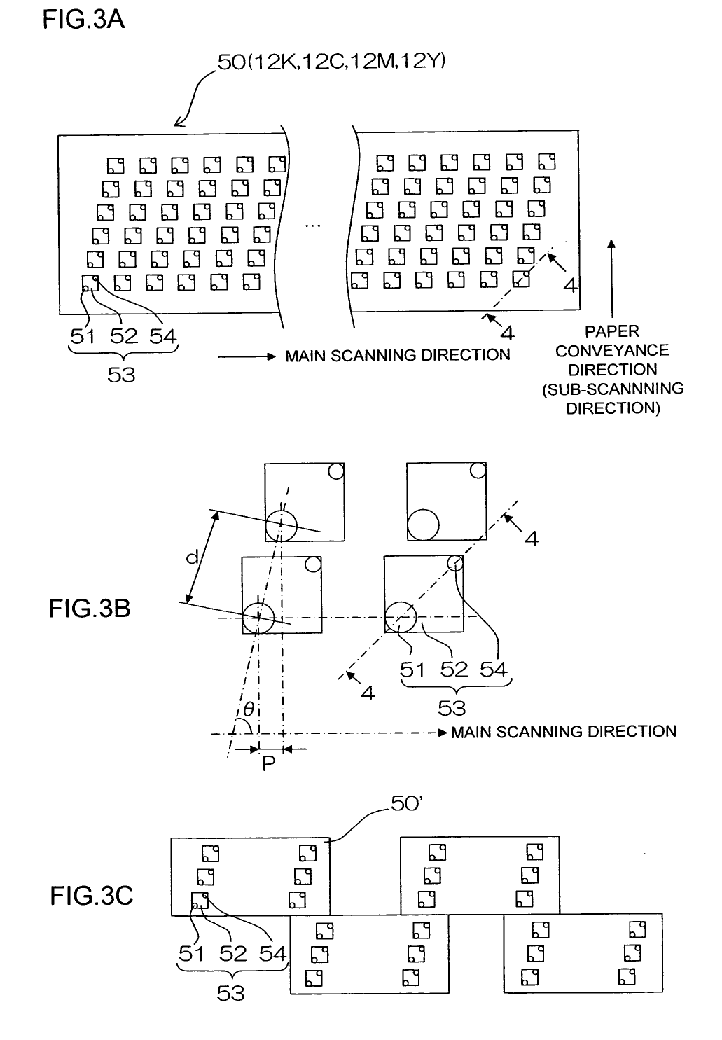

FIG. 3A is a perspective plan view showing an embodiment of the configuration of the head 50, FIG. 3B is an enlarged view of a portion thereof, and FIG. 3C is a perspective plan view showing another embodiment of the configuration of the head 50.

The nozzle pitch in the head 50 should be minimized in order to maximize the density of the dots printed on the surface of the recording paper 16. As shown in FIGS. 3A to 3C, the head 50 according to the present embodiment has a structure in which a plurality of ink chamber units 53 are disposed two-dimensionally in the form of a staggered matrix, and each ink chamber unit includes a nozzle 51 forming an ink droplet ejection port, a pressure chamber (liquid chamber) 52 corresponding to the nozzle 51, and the like. Hence, the effective nozzle interval (the projected nozzle pitch) as projected in the lengthwise direction of the head (the main scanning direction perpendicular to the paper conveyance direction) is reduced and high nozzle density is achieved.

The mode of forming one or more nozzle rows through a length corresponding to the entire width of the recording paper 16 in the main-scanning direction substantially perpendicular to the conveyance direction is not limited to the embodiment described above. For example, instead of the configuration in FIG. 3A, as shown in FIG. 3C, a line head having nozzle rows of a length corresponding to the entire width of the recording paper 16 can be formed by arranging and combining, in a staggered matrix, short head blocks 50′ having a plurality of nozzles 51 arrayed in a two-dimensional fashion.

The present embodiment describes a mode in which the planar shape of the pressure chambers 52 is substantially a square shape, but the planar shape of the pressure chambers 52 is not limited to being a substantially square shape, and it is possible to adopt various other shapes, such as a substantially circular shape, a substantially elliptical shape, and a substantially parallelogram (diamond) shape. Furthermore, the arrangement of the nozzles 51 and the supply ports 54 is not limited to the arrangement shown in FIGS. 3A to 3C, and it is also possible to arrange the nozzles 51 substantially in the central region of the pressure chambers 52, or to arrange the supply ports 54 in the side walls of the pressure chambers 52.

As shown in FIG. 3B, the high-density nozzle head according to the present embodiment is achieved by arranging a plurality of ink chamber units in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which a plurality of ink chamber units 53 are arranged at a uniform pitch d in line with a direction forming an angle of θ with respect to the main scanning direction, the pitch P of the nozzles projected so as to align the projected nozzles in the main scanning direction is d×cos θ, and hence the nozzles 51 can be regarded to be equivalent to those arranged linearly at a fixed pitch P in the main scanning direction. Such configuration results in a nozzle structure in which the nozzle row projected in the main scanning direction has a high nozzle density of up to 2,400 nozzles per inch.

When implementing the present invention, the arrangement structure of the nozzles is not limited to the embodiments shown in the drawings, and it is also possible to apply various other types of nozzle arrangements, such as an arrangement structure having one nozzle row in the sub-scanning direction and an arrangement structure having two staggered nozzle rows.

In a full-line head comprising rows of nozzles that have a length corresponding to the entire width of the image recordable width, the “main scanning” is defined as printing one line (a line formed of a row of dots, or a line formed of a plurality of rows of dots) in the width direction of the recording medium (main-scanning direction) by driving the nozzles in one of the following ways: (1) simultaneously driving all the nozzles; (2) sequentially driving the nozzles from one side toward the other; and (3) dividing the nozzles into blocks and sequentially driving the nozzles from one side toward the other in each of the blocks.

In particular, when the nozzles 51 arranged in a matrix, such as that shown in FIGS. 3A to 3C, are driven, the main scanning according to the above-described (3) is preferable.

On the other hand, “sub-scanning” is defined as to repeatedly perform printing of one line (a line formed of a row of dots, or a line formed of a plurality of rows of dots) formed by the main scanning, while moving the full-line head and the recording paper 16 relatively to each other.

In the present embodiment, a full line head is described, but the scope of application of the present invention is not limited to this and it can also be applied to a serial type of head which carries out printing in the breadthways direction of the recording paper 16 while moving a short head having nozzle rows of a length shorter than the width of the recording paper 16, in the breadthways direction of the recording paper 16.

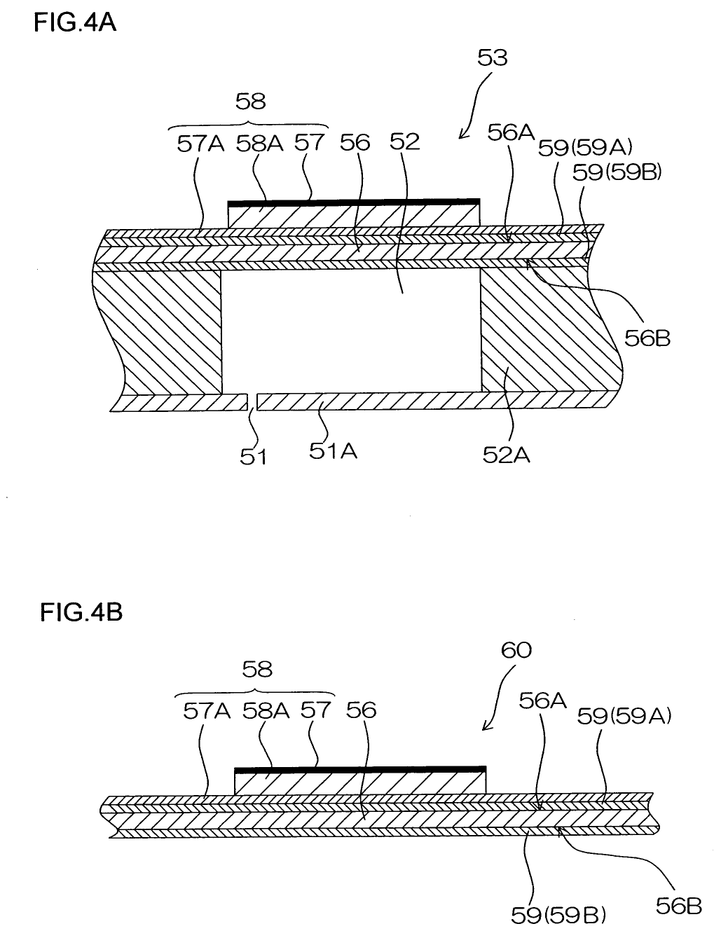

FIG. 4A is a cross-sectional diagram showing the composition of an ink chamber unit 53 (a cross-sectional diagram along line 4-4 in FIGS. 3A and 3B). Although not shown in FIG. 4A (see FIGS. 3A to 3C), the pressure chambers 52 provided respectively corresponding to the nozzles 51 are substantially square-shaped in plan view. As shown in FIG. 3B, the nozzles 51 and the supply ports 54, which are formed in a nozzle substrate 51A, are provided at either corner of diagonals of the pressure chambers 52. The pressure chambers 52 are connected to a common flow channel (common liquid chamber), which is not shown in FIG. 4A, through the supply ports shown in FIGS. 3A and 3B. The common flow channel is connected to an ink supply tank which is not shown in FIG. 4A, and ink supplied from the ink supply tank is distributed and supplied to the pressure chambers 52 via the common flow channel.

Piezoelectric elements 58 are bonded to the first surface 56A (piezoelectric element forming surface) of a diaphragm 56 (substrate) which constitutes the ceiling of the pressure chambers 52. Each piezoelectric element 58 comprises an upper electrode 57 using a metal such as platinum (Pt) or gold (Au), a lower electrode 57A, and a piezoelectric body 58A. In the present specification, an element in which the upper electrode 57 and the lower electrode 57A are formed respectively on both sides of the piezoelectric body 58A is called the piezoelectric element 58.

In the present embodiment, a common electrode is formed over the whole surface of the first surface 56A of the diaphragm 56 and it serves as the lower electrodes 57A for the plurality of piezoelectric elements 58. Furthermore, as shown in FIG. 4A, the individual piezoelectric bodies 58A are formed so as to correspond to the respective pressure chambers 52, and the individual upper electrodes (individual electrodes) 57 are formed so as to correspond to the respective piezoelectric bodies 58A.

In forming each piezoelectric body 58A, it is possible to form the piezoelectric bodies 58A by masking the regions where the piezoelectric bodies 58A are not to be formed, and it is also possible to form the piezoelectric body over the whole of the first surface 56A of the diaphragm 56 and then divide up this piezoelectric body in such a manner that the piezoelectric bodies 58A correspond to the pressure chambers 52 respectively. Moreover, it is also possible to form the piezoelectric body 58A over the whole surface of the diaphragm 56, and to form the upper electrodes 57 so as to correspond to the pressure chambers 52 respectively.

By applying a prescribed drive voltage to a piezoelectric element 58 (in other words, between the upper electrode 57 and the lower electrode 57A), a bending deformation is generated in the piezoelectric element 58, and the diaphragm 56 is caused to deform by this bending deformation, thus ink being ejected from the corresponding nozzle 51. When ink has been ejected from the nozzle 51, new ink is supplied to the corresponding pressure chamber 52 from the common flow channel, via the supply port 54.

A metal such as stainless steel is used for the diaphragm 56 of the present embodiment, and the diaphragm 56 has a thickness of approximately 10 μm (for example, 5 μm to 25 μm). Furthermore, for the piezoelectric elements 58, it is suitable to use a ceramic type of piezoelectric element, such as PZT (Pb(Zr—Ti)O₃: lead zirconate titanate), which has a thickness of approximately 10 μm (substantially the same thickness as the diaphragm 56).

It is suitable to use aerosol deposition (AD) for forming thin films of the piezoelectric bodies 58A described above. The piezoelectric bodies 58A formed by the AD are calcined by an annealing process at a temperature of 400° C. or above (for example, 400° C. to 1200° C.).

In the head 50 according to the present embodiment, a metal oxide film 59 (59A) including at least one metal oxide film of aluminum oxide (for example, Al₂O₃), zirconium oxide (for example, ZrO₂) and silicon oxide (for example, SiO₂) is formed between the diaphragm 56 and the piezoelectric elements 58 (the first surface 56A of the diaphragm 56 above which the piezoelectric elements 58 are formed).

This metal oxide film 59 is deposited by a thin film deposition technique, such as ion plating, sol gel method, sputtering, or CVD. During the annealing process for calcining the piezoelectric bodies 58A, the iron contained in the diaphragm 56 where the metal oxide film 59 is provided on the first surface 56A, is prevented from diffusing into the piezoelectric bodies 58A, and therefore it is possible to prevent degradation of the performance of the piezoelectric elements 58, such as decline in the piezoelectric d constant (electrical-mechanical conversion constant) of the piezoelectric elements 58 and decline in the insulation resistance between each upper electrode 57 and each lower electrode 57A.

Furthermore, in the head 50 according to the present embodiment, the metal oxide film 59 (59B) described above is also formed on a surface (second surface) 56B of the diaphragm 56 reverse to the surface (first surface) on which the piezoelectric elements 58 are bonded. The metal oxide film 59B formed on the second surface 56B has the same composition as the metal oxide film 59A formed on the first surface 56A, and this metal oxide film 59B prevents oxidation of the second surface 56B of the diaphragm 56 (for example, generation of iron oxide). For example, if the second surface 56B of the diaphragm 56 (the surface of the diaphragm 56 to be bonded with the liquid chamber substrate 52A) is oxidized, then there is a concern about degradation of bonding characteristics when the diaphragm 56 and the liquid chamber substrate 52A formed with pressure chambers 52, and the like, are bonded together. However, by protecting the bonding surface with the metal oxide film 59, it is possible to prevent deterioration of the bonding characteristics.

It is possible to adopt a mode in which the supply ports 54 described above, the common flow channel (not shown), ejection-side flow channels (not shown) which connect the nozzles 51 with the pressure chambers 52, and supply-side flow channels (not shown) which connect the supply ports 54 with the common liquid chamber, and the like, are formed in the liquid chamber substrate 52A. Moreover, it is also possible to compose the liquid chamber substrate 52A by means of a plurality of substrates. For example, it is possible to adopt a composition in which a pressure chamber substrate including the pressure chambers 52, a common liquid chamber substrate including the common liquid chamber, a supply port substrate including the supply ports 54 and the supply-side flow channels, and an ejection-side flow channel substrate including the ejection-side flow channels, are superposed and bonded together while they are registered in position.

It is also possible to adopt a mode in which a bonding member, such as adhesive, is used for bonding the substrates together, and moreover, it is possible to adopt a mode in which the substrates are bonded together by applying heat and/or pressure, such as diffusion bonding.

In the present embodiment, although a mode is described where single layers of the metal oxide films 59 are formed on the first surface 56A and the second surface 56B of the diaphragm 56 respectively, it is also possible to provide each metal oxide film 59 formed by two or more layers having different compositions. In a mode where each metal oxide film 59 is constituted by a plurality of layers, the total thickness of these layers corresponds to the thickness of the metal oxide film 59.

FIG. 4B is a diagram showing a piezoelectric actuator 60 according to the present embodiment. In other words, as shown in FIG. 4B, each piezoelectric actuator 60 is constituted by the diaphragm 56 and a piezoelectric element 58, and it has a structure in which the diaphragm 56 is deformed in the vertical direction in FIGS. 4A and 4B in accordance with the bending deformation of the piezoelectric element 58. The piezoelectric elements 58 according to the present embodiment have a d₃₁ deformation mode whereby, when drive signals are applied to the piezoelectric elements 58 in a thickness direction (the vertical direction in FIG. 4B) of the piezoelectric elements 58, then the piezoelectric elements 58 generates bending distortion in a direction substantially perpendicular to the direction of application of the voltage. The diaphragm 56 is caused to deform in a direction substantially perpendicular to the direction of the bending deformation of the piezoelectric elements 58 (i.e., the direction in which the drive signal is applied to the piezoelectric elements 58), thereby changing the volume of the pressure chambers 52.

In a composition where a thin-film diaphragm 56 and a d₃₁ mode piezoelectric element 58 having a single-layer thin-film structure are used for the piezoelectric actuator 60 shown in FIG. 4B, it is possible to obtain a large amount of the displacement by applying a drive signal of low voltage.

FIGS. 4A and 4B show a mode where the metal oxide films 59 are deposited onto both the first surface 56A and the second surface 56B of the diaphragm 56 respectively; however, if a metal oxide film 59 is deposited at least onto the first surface 56A of the diaphragm 56, it is possible to prevent the diffusion of iron into the piezoelectric bodies 58A.

Description of Control System

FIG. 5 is a principal block diagram showing the system configuration of the inkjet recording apparatus 10. The inkjet recording apparatus 10 includes a communications interface 70, a system controller 72, a memory 74, a motor driver 76, a heater driver 78, a print controller 80, an image buffer memory 82, a head driver 84, and the like.

The communications interface 70 is an interface unit for receiving image data sent from a host computer 86. A serial interface such as USB (Universal serial bus), IEEE1394, Ethernet (registered trademark), wireless network, or a parallel interface such as a Centronics interface may be used as the communications interface 70. A buffer memory (not shown) may be mounted in this portion in order to increase the communication speed. The image data sent from the host computer 86 is received by the inkjet recording apparatus 10 through the communications interface 70, and is temporarily stored in the memory 74. The memory 74 is a storage device for temporarily storing images inputted through the communications interface 70, and data is written and read to and from the memory 74 through the system controller 72. The memory 74 is not limited to a memory composed of semiconductor elements, and a hard disk drive or another magnetic medium may be used.

The system controller 72 is a control unit for controlling the various sections, such as the communications interface 70, the memory 74, the motor driver 76, and the heater driver 78. The system controller 72 is constituted by a central processing unit (CPU) and peripheral circuits thereof, and the like, and in addition to controlling communications with the host computer 86 and controlling reading and writing from and to the memory 74, and the like, it also generates control signals for controlling the motor 88 of the conveyance system and the heater 89.

The motor driver (drive circuit) 76 drives the motor 88 in accordance with commands from the system controller 72. The heater driver 78 drives the heater 89 of the post-drying unit 42 (shown in FIG. 1), and the like, in accordance with commands from the system controller 72.

The print controller 80 has a signal processing function for performing various tasks, corrections, and other types of processing for generating print control signals from the image data stored in the memory 74 in accordance with commands from the system controller 72 so as to apply the generated print control signals to the head driver 84. Required signal processing is carried out in the print controller 80, and the ejection amount and the ejection timing of the ink droplets from the print head 50 are controlled via the head driver 84, on the basis of the print data. By this means, desired dot size and dot positions can be obtained.

The print controller 80 is provided with the image buffer memory 82; and image data, parameters, and other data are temporarily stored in the image buffer memory 82 when image data is processed in the print controller 80. FIG. 5 shows an aspect in which the image buffer memory 82 accompanies the print controller 80; however, the memory 74 may also serve as the image buffer memory 82. Also possible is an aspect in which the print controller 80 and the system controller 72 are integrated to form a single processor.

The head driver 84 drives the piezoelectric elements 58 of the heads of the respective colors 12K, 12C, 12M, and 12Y on the basis of print data supplied by the print controller 80.

The head driver 84 can be provided with a feedback control system for maintaining constant drive conditions for the print heads.

Various control programs are stored in a program storage section 90, and the control programs are read out and executed in accordance with commands from the system controller 72. The program storage section 90 may use a semiconductor memory such as a ROM or EEPROM, or a magnetic disk, or the like. Further, an external interface may be provided, and a memory card or PC card may also be used. Naturally, a plurality of these storage media may also be provided. The program storage section 90 may also be combined with a storage device (not shown) for storing operational parameters, or the like.

The print determination unit 24 is a block that includes the line sensor as described above with reference to FIG. 1, reads an image printed on the recording paper 16, determines the print conditions (presence of the ejection, variation in the dot formation, and the like) by performing required signal processing, and the like, and provides the determination results of the print conditions to the print controller 80. According to requirements, the print controller 80 makes various corrections with respect to the head 50 on the basis of information obtained from the print determination unit 24.

The system controller 72 and the print controller 80 may be constituted by one processor, and it is also possible to use a device where the system controller 72, the motor driver 76, and the heater driver 78 are combined integrally, or a device where the print controller 80 and the head driver are combined integrally.

Description of Thickness of Metal Oxide Film

If the thickness of the metal oxide films 59 shown in FIGS. 4A and 4B becomes lower than a prescribed value, then it does not satisfactorily perform the function of preventing diffusion of the iron into the piezoelectric elements 58. On the other hand, if the thickness of the metal oxide films 59 becomes greater than a prescribed value, this is equivalent to increasing the thickness of the diaphragm 56 due to the thickness of the metal oxide films 59, and the amount of displacement of the diaphragm 56 thus declines, even when pressure is generated by the piezoelectric elements 58. Consequently, in these cases, it is difficult to assure the prescribed ejection characteristics.

In other words, from the viewpoint of preventing the diffusion of iron into the piezoelectric elements 58, it is desirable for the metal oxide films 59 to have a large thickness; whereas from the viewpoint of assuring the sufficient amount of displacement of the diaphragm 56, it is desirable for the metal oxide films 59 to have a small thickness. Hence, the desirable thickness range of the metal oxide films 59 is determined with reference to the two viewpoints described above.

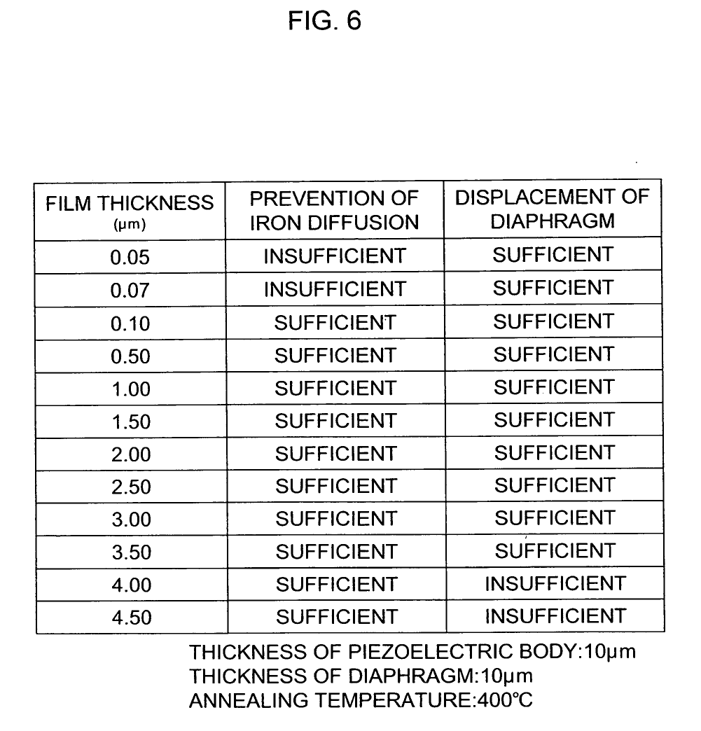

FIG. 6 is a table showing experimental data which indicates the prevention or non-prevention of the iron diffusion (analyzed by an EDX composition analyzer) and the acceptability or unacceptability of the amount of displacement of the diaphragm 56 (in other words, whether or not the prescribed amount of displacement is sufficiently obtained), while the thickness of the metal oxide films 59 is varied from 0.05 μm to 4.5 μm. A sign of “SUFFICIENT” in FIG. 6 denotes that: with regard to the prevention of iron diffusion, diffusion of the iron into the piezoelectric bodies 58A was sufficiently prevented; and with regard to the displacement of diaphragm, sufficient displacement of the diaphragm was obtained. On the other hand, a sign of “INSUFFICIENT” in FIG. 6 denotes that: with regard to the prevention of iron diffusion, the prevention of the iron diffusion into the piezoelectric bodies 58A was insufficient; and with regard to the displacement of diaphragm, sufficient displacement of the diaphragm was not obtained. Furthermore, the data shown in FIG. 6 were obtained at the experimental conditions in which the diaphragm 56 has a thickness of 10 μm, the piezoelectric bodies 58A have a thickness of 10 μm, and annealing temperature is 400° C.

As shown in FIG. 6, if the thickness of each metal oxide film 59 was not greater than 0.07 μm, then the prevention of iron diffusion was insufficient. On the other hand, if the thickness of each metal oxide film 59 was not less than 4.0 μm, then a sufficient amount of displacement of the diaphragm 56 was not obtained. According to these results, desirably, the film thickness of the metal oxide films 59 described above is not less than 0.1 μm and not greater than 3.5 μm.

In a mode where metal oxide films 59 (59A, 59B) can be formed respectively on the first surface 56A and the second surface 56B of the diaphragm 56, the lower limit value of the thickness of the metal oxide film 59 shown in FIGS. 4A and 4B indicates the thickness of the metal oxide film 59A (see FIGS. 4A and 4B) deposited onto the first surface of the diaphragm 56 in a case where only the metal oxide film 59A is formed (i.e., the metal oxide film 59B is not formed). On the other hand, the upper limit value of the metal oxide film 59 shown in FIGS. 4A and 4B indicates the total of the thickness of the metal oxide film 59A deposited onto the first surface 56A of the diaphragm 56, plus the thickness of the metal oxide film 59B deposited on the second surface 56B in a case where both the metal oxide films 59A and 59B are formed.

Description of Head Manufacturing Method

Next, a method of manufacturing the head 50 shown in the present embodiment is described below. The head 50 shown in the present embodiment has a laminated structure in which a plurality of cavity plates (substrates) are stacked together. In other words, as shown in FIG. 4A, a structure is obtained in which a nozzle substrate 51 A including the nozzles 51, a liquid chamber substrate 52A including the pressure chambers 52, the supply ports 54 (see FIGS. 3A and 3B; not shown in FIG. 4A), and the common flow channel, the diaphragm 56 on which the metal oxide film(s) 59 is formed, and the piezoelectric elements 58 including the upper electrodes 57 and the lower electrode 57A, are stacked together in this order. Each of the cavity plates described above may be composed by one plate or may be constituted by a plurality of plates.

For example, there is a mode in which the liquid chamber substrate 52A is formed by stacking together a plate including the ejection-side flow channels which connect the nozzles 51 with the pressure chambers 52, a plate including the common flow channel, a plate including the supply ports 54, and a plate including the pressure chambers 52.

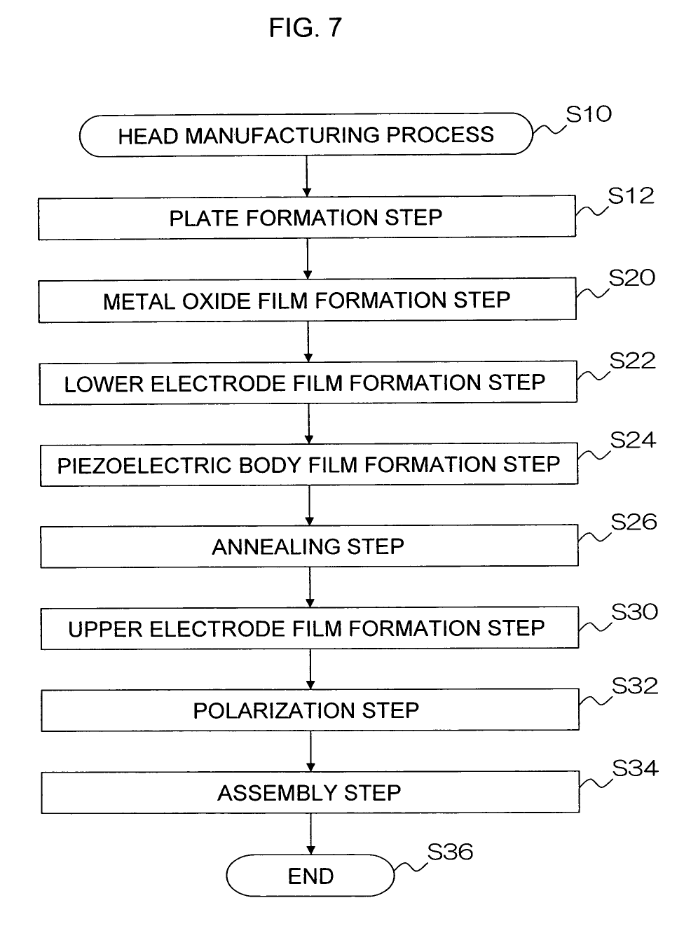

FIG. 7 is a flowchart showing steps of manufacturing the head 50 according to the present embodiment. As described in detail below, in order to bond these plates together, a bonding method, such as bonding by means of a bonding member or bonding by heating and pressurization, is selected appropriately in accordance with the material of the plates.

According to a head manufacturing process (step S10) according to the present embodiment, firstly, the plates which constitute the head 50 are formed in a plate formation step (step S12). For example, a substrate of stainless steel or synthetic resin is used for the nozzle substrate 51A of the present embodiment. Furthermore, a metal substrate of stainless steel, titanium, titanium alloy, aluminum, aluminum alloy, or the like, is used for the liquid chamber substrate 52A. Apart from the metal substrate, it is also possible to use a green sheet in which glass powders are dispersed into a binder such as an acrylic resin, and then formed into a sheet. For the glass powders contained in the green sheet, a material is selected which is not softened under the heat treatment conditions during the annealing process described below.

In a metal oxide film formation step (step S20), a metal oxide film 59 is formed over the whole surface of at least one of the first surface 56A and the second surface 56B of the diaphragm 56 which is formed by a stainless steel substrate containing iron. For this metal oxide film formation step, a film formation method, such as AD (aerosol deposition), ion-plating, a sol gel method, sputtering, CVD, or screen printing, is used. In the mode shown in FIGS. 4A and 4B, the metal oxide films 59 are deposited on both surfaces of the diaphragm 56 respectively.

The AD (aerosol deposition) method is a film formation method in which, for example, a substrate and an aerosol nozzle are moved relatively with respect to each other in a chamber while metal micro-particles (aerosol) of submicron-order diameter carried by nitrogen gas, or the like, are blown from the aerosol nozzle onto the substrate, in such a manner that the crystals are formed at prescribed positions on the surface of the substrate.

In a mode where the metal oxide films 59 are formed respectively on both the first surface 56A and the second surface 56B of the diaphragm 56, it is more preferable that the metal oxide films 59 be formed by using a sol gel method and an ion plating method, since this allows the metal oxide films 59A and 59B to be formed simultaneously on both the first surface 56A and the second surface 56B of the diaphragm 56.

The sol gel method is a method in which, for example, a sol composition capable of forming a metal oxide film is applied onto the whole surface of the diaphragm 56 by spin coating, dip coating, roll coating, bar coating screen printing, spraying, or the like, and is then dried for approximately 5 minutes at a temperature of 75° C. to 200° C. By repeating the application and drying steps a plurality of times, it is possible to increase the thickness of the metal oxide films 59.

The ion plating method is a method for depositing the metal oxide film 59, for example, by attracting vapor and gas of ionized metal oxide to the surface of a substrate (diaphragm 56) by applying a voltage of several tens of volts. By combining the ion plating method and use of electrical energy, it is possible to form the metal oxide films 59 which has a high bonding strength at a low temperature of 500° C. or below.

In a lower electrode film formation step (step S22), a metal thin film of platinum or gold which is to form the lower electrode 57A is formed on the metal oxide film 59 formed on the first surface 56A of the diaphragm 56 in the metal oxide film deposition step. For the lower electrode film formation step, a film formation method such as aerosol deposition, sputtering, or screen printing, is used. The lower electrode 57A is formed over the whole of one surface of the diaphragm 56 and it serves as the common electrode for each piezoelectric element 58. Naturally, it is also possible to form individual lower electrodes 57A in regions corresponding to the respective piezoelectric elements 58.

Next, in a piezoelectric body formation step (step S24), the piezoelectric bodies (piezoelectric films) 58A are formed onto the lower electrode 57A. A thin film formation method, such as aerosol deposition, a sol gel method, sputtering, CVD, or screen printing, is suitably used in the piezoelectric body formation step. The piezoelectric bodies 58A formed in step S26 may be formed individually so as to correspond to the pressure chambers respectively, or alternatively, similarly to the lower electrode 57A, a single piezoelectric body 58A may be formed over the whole of a surface of the diaphragm 56, and then be divided up so as to correspond to each of the pressure chambers 52.

If AD (aerosol deposition) is used as the film formation method in the metal oxide film formation step (step S20), the lower electrode film formation step (step S22), and the piezoelectric body formation step (step S24), then it is possible to form various different types of thin films simply by changing the aerosol nozzle, and therefore this contributes to simplification of the manufacturing process.

In an annealing step (step S26), an annealing process is carried out under temperature conditions of 400° C. to 1200° C. (400° C. or above), and hence the films of the piezoelectric bodies 58A formed in step S24 is calcined.

Next, in an upper electrode formation step (step S30), thin metal films which are made of platinum, gold or the like, and which are to function as the upper electrodes 57, are formed onto the piezoelectric bodies 58A that have undergone annealing in step S26 by means of a film formation method such as aerosol deposition, sputtering, or screen printing.

In step S32 (polarization step), wiring members, such as a flexible substrate, are connected to the upper electrodes 57 and the lower electrode 57A, and the piezoelectric bodies 58A are polarized by applying a prescribed voltage between the upper electrodes 57 and the lower electrode 57A. In the polarization processing according to the present embodiment, polarization is carried out in the thickness direction of the piezoelectric bodies 58A (in a direction substantially perpendicular to the surface of the diaphragm 56). The voltage applied during the polarization processing is higher than the drive voltage used when the piezoelectric elements 58 are driven.

After the polarization in step S32, the portion of each piezoelectric body 58A where the upper electrode 57 is formed serves as an active piezoelectric section for generating a bending deformation when a prescribed drive signal is applied, and the active piezoelectric sections function as piezoelectric elements which apply ejection force to ink inside the corresponding pressure chambers 52.

At step S34, a liquid chamber substrate 52A is bonded to the diaphragm 56 and the piezoelectric elements 58 (piezoelectric actuators 60) which are formed in steps S10 to S32, and moreover, a nozzle substrate 51A is bonded onto the surface of the liquid chamber substrate 52A reverse to the surface on which the diaphragm 56 is bonded, thereby obtaining the head 50. The head 50 is subjected to prescribed inspections and is then incorporated into the main body of the inkjet recording apparatus 10 (step S36).

For the portions which are not subjected to the annealing process in step S26, it is possible to use a resin material having low thermal resistance, and a bonding member and a bonding method are selected appropriately in accordance with the material used.

The manufacturing process shown in FIG. 7 is simply one embodiment, and processes, such as a heat treatment process and a pressurization process, are carried out appropriately in accordance with the film formation methods used in the lower electrode film formation step, the piezoelectric body film formation step and the upper electrode film formation step.

In the head 50 thus obtained, the metal oxide film 59 (59A) which contains at least one oxide of an aluminum oxide, zirconium oxide and silicon oxide and has a film thickness not less than 0.1 μm and not greater than 3.5 μm is formed onto the first surface (piezoelectric element forming surface) 56A of the diaphragm 56, on which the piezoelectric elements 58 are formed; the piezoelectric elements 58 comprising the piezoelectric bodies 58A are formed on the metal oxide film 59 by a thin film formation method; and an annealing process (calcination process) is carried out at a temperature of 400° C. or above. Therefore, diffusion of the iron contained in the diaphragm 56, into the piezoelectric elements 58, is prevented by the metal oxide film 59, and hence deterioration of the performance of the piezoelectric elements 58 is prevented.

Furthermore, in a mode where the metal oxide film 59 (59B) is also formed onto the second surface 56B (the surface where the piezoelectric elements are not formed) of the diaphragm 56, deterioration due to oxidation of the diaphragm 56 is prevented, and the bonding characteristics of the second surface 56B are ensured.

### Further Embodiment

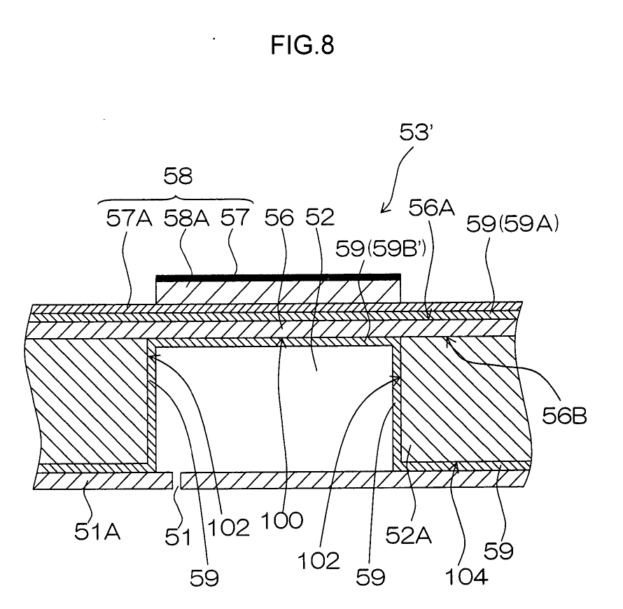

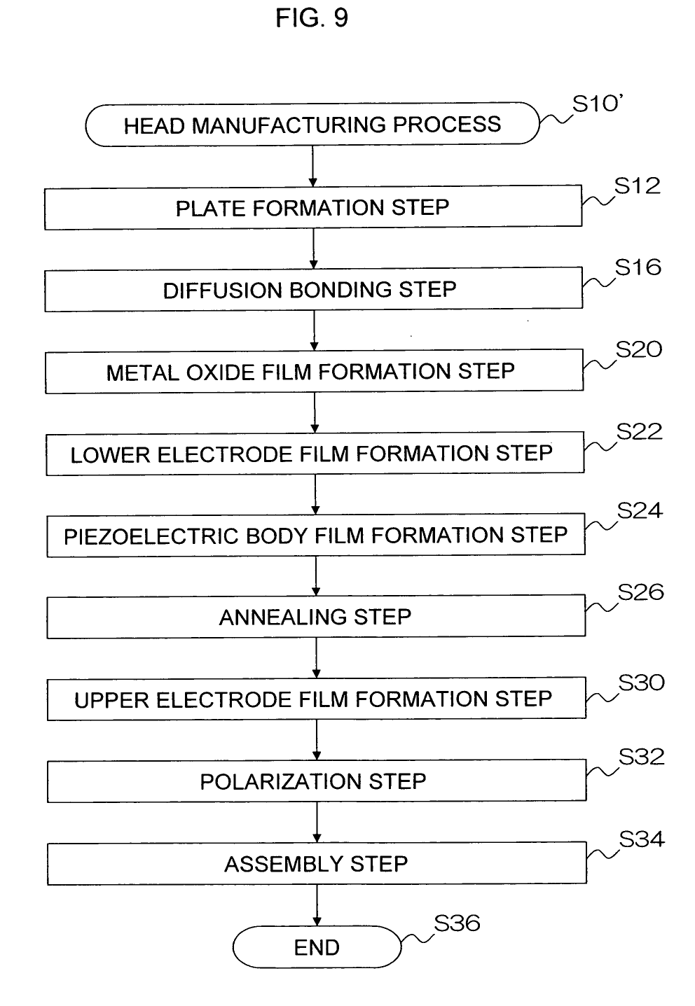

Next, a further embodiment of the present invention is described below. FIG. 8 is a diagram showing a further mode of the ink chamber units 53 as shown in FIG. 4A, and FIG. 9 is a flowchart showing a manufacturing process for the head 50 comprising the ink chamber units 53′ as shown in FIG. 8. In FIGS. 8 and 9, items which are the same as or similar to those in FIGS. 4A and 7 are labeled with the same reference numerals, and description thereof is omitted here.

In each ink chamber unit 53′ as shown in FIG. 8, the metal oxide film 59 (59A) is formed on the first surface 56A of the diaphragm 56, and the metal oxide films 59 (59B′) are formed on the parts 100 of the second surface 56B of the diaphragm 56 which form the inner wall surfaces (ceiling faces) of the pressure chambers 52.

Moreover, the metal oxide films 59 are also formed on the inner wall surfaces (side wall surfaces) 102 of each pressure chamber 52 in the liquid chamber substrate 52A, and on the bonding surface 104 of the liquid chamber substrate 52A which is situated on a side near the nozzle substrate 51A (i.e., between the liquid chamber substrate 52A and the nozzle substrate 51A).

In other words, in the mode shown in FIG. 8, the metal oxide films 59 are formed on the first surface 56A of the diaphragm 56, the internal wall surfaces 100 and 102 of the pressure chambers 52, and the bonding surface 104 of the liquid chamber substrate 52A with respect to the nozzle substrate 51A.

By also forming the metal oxide films 59 inside the pressure chambers 52, it is possible to prevent deterioration of the pressure chambers 52 due to the presence of ink, and to improve the ink resistance properties. Moreover, by also forming the metal oxide film 59 on the bonding surface 104 of the liquid chamber substrate 51A with respect to nozzle substrate 51A, it is possible to prevent oxidation of the bonding surface 104 during heat treatment, and therefore good bonding characteristics are ensured between the liquid chamber substrate 52A and the nozzle substrate 51A.

FIG. 9 is a flowchart showing a manufacturing process for the head 50 including the ink chamber units 53′ as shown in FIG. 8. According to the manufacturing process for the head 50 shown in FIG. 9, plates are formed in a plate forming step (step S12), and then the liquid chamber substrate 52A is bonded to the diaphragm 56 (step S16).

In a mode which uses a metal material, such as stainless steel, for the liquid chamber substrate 52A, diffusion bonding is suitably used for bonding the diaphragm 56 with the liquid chamber substrate 52A. Diffusion bonding is a bonding method in which, for example, the diaphragm 56 and the liquid chamber substrate 52A are bonded together by pressurizing a laminated body of the diaphragm 56 and the liquid chamber substrate 52A at a prescribed pressure and for a prescribed time, while the laminated body of the diaphragm 56 and the liquid chamber substrate 52A is heated at or above the recrystallization temperature (e.g., 1000° C. to 1300° C.) in a vacuum or inert gas (nitrogen, argon, etc.) atmosphere. As an embodiment of the pressure conditions and the time conditions described above, there is a mode in which the pressurization is carried out for 0.5 hours to 24 hours at a pressure of 4.9 MPa to 19.6 MPa.

When the diaphragm 56 and the liquid chamber substrate 52A is bonded together in the bonding step, then the metal oxide film 59 is formed onto the first surface 56A of the diaphragm 56, and furthermore, the metal oxide films 59 are also formed onto the inner wall surfaces 100 and 102 of the pressure chambers 52 (see FIG. 8) and the bonding surface 104 of the liquid chamber substrate 52A with respect to the nozzle substrate 51A (step S20).

If the metal oxide films 59 are formed by a sol gel method, ion plating or CVD, then it is possible to form the metal oxide films 59 simultaneously onto the first surface 56A of the diaphragm 56, the inner wall surfaces 100 and 102 of the pressure chambers 52, and the bonding surface 104 of the liquid chamber substrate 52A with respect to the nozzle substrate 51A.

After the metal oxide film formation process, steps which are similar to those of the manufacturing process shown in FIG. 7 are carried out. In other words, a lower electrode film formation step (step S22), a piezoelectric body film formation step (step S24), an annealing step (step S26), an upper electrode film formation step (step S30), a polarization process (step S32) and an assembly step (step S34) are carried out, thereby obtaining the head 50 (step S36).

The metal oxide films 59 formed onto the surfaces of the diaphragm 56 and the liquid chamber substrate 52A may have the same compositions or they may have different compositions. Furthermore, the metal oxide films formed onto the surfaces may have the same thickness or they may have different thicknesses.

In the mode shown in FIG. 8, from the viewpoint of preventing diffusion of the iron into the piezoelectric bodies 58A, it is preferable that the metal oxide film 59 (59A) formed onto the first surface 56A of the diaphragm 56 have a film thickness of 0.1 μm or above. On the other hand, from the viewpoint of ensuring the amount of displacement of the diaphragm 56, it is preferable that the metal oxide film 59 (59A) formed on the first surface 56A of the diaphragm 56 and the metal oxide films 59 (59B′) formed on the regions 100 of the diaphragm 56 forming inner wall surfaces of the pressure chambers 52 have a total thickness of 3.5 μm or less. Preferably, the metal oxide films 59 formed on the liquid chamber substrate 52A have substantially the same thickness as the metal oxide films 59 (59B′) formed on the regions 100 of the diaphragm 56 forming the inner wall surfaces of the pressure chambers 52, and in this case, it becomes easy to control the film thickness in the metal oxide film formation step.

In the present embodiment, an inkjet recording apparatus which forms a prescribed image by ejecting ink onto the recording medium 16 is described, but the present invention can also be applied to a liquid ejection apparatus which ejects liquid (such as treatment liquid, chemical solution, or water) onto a medium.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A method of manufacturing a piezoelectric actuator, comprising the steps of:
forming a first metal oxide film which contains at least one element of aluminum, zirconium and silicon and has a film thickness of not less than 0.1 μm and not greater than 3.5 μm, on a first surface of a main substrate containing iron;
forming a piezoelectric element including a piezoelectric body formed by a thin film formation method, on the first metal oxide film formed on the first surface of the main substrate; and
calcining the piezoelectric body by carrying out heat treatment at a temperature of not less than 400° C., in a state where the piezoelectric element has been formed on the first metal oxide film formed on the first surface of the main substrate.

2. The method of manufacturing a piezoelectric actuator as defined in claim 1, further comprising the step of forming a second metal oxide film which contains at least one element of aluminum, zirconium and silicon, on a second surface of the main substrate reverse to the first surface.

3. A method of manufacturing a liquid ejection head which ejects liquid onto a recording medium, comprising the steps of:
forming a first metal oxide film which contains at least one element of aluminum, zirconium and silicon and has a film thickness of not less than 0.1 μm and not greater than 3.5 μm, on a first surface of a main substrate containing iron;
forming a piezoelectric element including a piezoelectric body formed by a thin film formation method, on the first metal oxide film formed on the first surface of the main substrate;
calcining the piezoelectric body by carrying out heat treatment at a temperature of not less than 400° C., in a state where the piezoelectric element has been formed on the first metal oxide film formed on the first surface of the main substrate; and
bonding a liquid chamber substrate including a liquid chamber for accommodating the liquid, to a second surface of the main substrate reverse to the first surface, after calcining the piezoelectric body.

4. The method of manufacturing a liquid ejection head as defined in claim 3, further comprising the step of forming a second metal oxide film which contains at least one element of aluminum, zirconium and silicon, on the second surface of the main substrate.

5. A method of manufacturing a liquid ejection head which ejects liquid onto a recording medium, comprising the steps of:
forming a first metal oxide film which contains at least one element of aluminum, zirconium and silicon and has a thickness of not less than 0.1 μm and not greater than 3.5 μm, on a first surface of a main substrate containing iron;
bonding a liquid chamber substrate including a liquid chamber for accommodating the liquid, to a second surface of the main substrate reverse to the first surface;
forming a piezoelectric element including a piezoelectric body formed by a thin film formation method, on the first metal oxide film formed on the first surface of the main substrate, at a position corresponding to the liquid chamber of a laminated body in which the main substrate and the liquid chamber substrate are bonded together; and
calcining the piezoelectric body by carrying out heat treatment at a temperature of not less than 400° C., in a state where the piezoelectric element has been formed on the first metal oxide film formed on the first surface of the main substrate.

6. The method of manufacturing a liquid ejection head as defined in claim 5, further comprising the step of forming second metal oxide films which contain at least one element of aluminum, zirconium and silicon, on a portion of the second surface that corresponds to the liquid chamber in the liquid chamber substrate and on an inner wall surface of the liquid chamber in the liquid chamber substrate.

7. The method of manufacturing a liquid ejection head as defined in claim 5, further comprising the step of forming a second metal oxide film which contains at least one element of aluminum, zirconium and silicon, on a first surface of the liquid chamber substrate reverse to a second surface of the liquid chamber substrate to which the main substrate is bonded.

8. The method of manufacturing a liquid ejection head as defined in claim 3, further comprising the step of bonding a nozzle substrate including a nozzle for ejecting the liquid accommodated in the liquid chamber, to a first surface of the liquid chamber substrate reverse to a second surface of the liquid chamber substrate to which the main substrate is bonded.

9. The method of manufacturing a liquid ejection head as defined in claim 5, further comprising the step of bonding a nozzle substrate including a nozzle for ejecting the liquid accommodated in the liquid chamber, to a first surface of the liquid chamber substrate reverse to a second surface of the liquid chamber substrate to which the main substrate is bonded.

10. A piezoelectric actuator, comprising:
a main substrate which contains iron;
a first metal oxide film which is formed on a first surface of the main substrate, contains at least one element of aluminum, zirconium and silicon, and has a film thickness of not less than 0.1 μm and not greater than 3.5 μm; and
a piezoelectric element including a piezoelectric body formed on the first metal oxide film on the first surface of the main substrate.

11. The piezoelectric actuator as defined in claim 10, further comprising a second metal oxide film which is formed on a second surface of the main substrate reverse to the first surface and contains at least one element of aluminum, zirconium and silicon.

12. The piezoelectric actuator as defined in claim 10, wherein each of the main substrate and the piezoelectric body has a thickness of not less than 1 μm and not greater than 40 μm.

13. A liquid ejection head which ejects liquid toward a recording medium, comprising:
a main substrate which contains iron;
a metal oxide film which is formed on a first surface of the main substrate, contains at least one element of aluminum, zirconium and silicon, and has a film thickness of not less than 0.1 μm and not greater than 3.5 μm;
a piezoelectric element including a piezoelectric body formed on the metal oxide film on the first surface of the main substrate; and
a liquid chamber substrate which includes a liquid chamber for accommodating the liquid, and is bonded to a second surface of the main substrate reverse to the first surface.

14. An image forming apparatus comprising the liquid ejection head as defined in claim 13.
